(19) United States
(12) Patent Application Publication
(10) Pub. No.: US 2024/0112131 A1
(43) Pub. Date: Apr. 4, 2024

(54) LOCATION DETERMINATION

(71) Applicant: MASTERCARD INTERNATIONAL INCORPORATED, PURCHASE, NY (US)

(72) Inventors: ALAN JOHNSON, MALDON (GB); SIMON PHILLIPS, YORK (GB)

(73) Assignee: MASTERCARD INTERNATIONAL INCORPORATED, PURCHASE, NY (US)

(21) Appl. No.: 18/029,052

(22) PCT Filed: Sep. 14, 2021
(86) PCT No.: PCT/US2021/050167

§ 371 Date: Mar. 28, 2023

(30) Foreign Application Priority Data
Sep. 28, 2020 (GB) 2015345.8

(51) Int. Cl. G06Q 10/087; G06V 20/69

(52) U.S. Cl. CPC G06Q 10/087; G06V 20/693

(57) ABSTRACT

The present invention relates to an apparatus, a method, and a system for determining location. The apparatus comprises an apparatus comprising a camera, and a processor. The camera is configured to capture an image of a microscopic object located at a predetermined location. The microscopic object comprises coded information. The processor is configured to process the image to decode the coded information and to determine a location of the device as being the predetermined location based on the decoded information. The apparatus may further comprise a manually operated inventory carrier (such as a shopping trolley or cart) or a robotic inventory carrier. The predetermined location may be in a supermarket or an inventory facility. The microscopic object may comprise a QR code or other barcode, and may be one of an array or repeating patterns of microscopic objects.

### CROSS-REFERENCE TO RELATED APPLICATION

This application claims the benefit of, and priority to, United Kingdom Patent Application No. 2015345.8, filed Sep. 28, 2020. The entire disclosure of the above application is incorporated herein by reference.

### FIELD OF THE INVENTION

The present disclosure relates to an apparatus for determining location. The present disclosure also relates to a method of determining location.

It is known to determine the location of a device using a signal received by the device from a source external to the device. For example, a radio frequency signal or a GPS signal may be used. In some situations, the device may not be able to receive an external signal, for example if the device is inside a building and the building contains a number of objects which obstruct the signal.

In order to determine the location of a device within an environment, it is known to provide images at known locations within the environment which can be recognized by the device and subsequently used to determine the location of the device. Such images may present a security risk, in that unauthorized personnel may be able to locate the images and use an unauthorized device to navigate the environment or tamper with the images.

### SUMMARY OF THE INVENTION

According to an aspect of the invention, there is provided an apparatus for determining location. The apparatus comprises a device and a processor. The device comprises a camera configured to capture an image of a microscopic object located at a predetermined location, the microscopic object comprising coded information. The processor is configured to decode the coded information and determine a location of the device as being the predetermined location based on the decoded information.

Coded information in the context of the invention means any predetermined pattern, predetermined arrangement of shapes, predetermined sequence of numbers and/or letters, or any other visual representation of information that can be distinguished from other coded information and any non-predetermined, e.g. pre-existing, pattern, arrangement of shapes, and sequence of numbers and/or letters. Examples of coded information include binary codes, such as QR codes or barcodes, plain text, or pointers to a resource in memory (e.g. a URI, URL memory address location etc.).

The microscopic object may be two dimensional. The microscopic object may be three dimensional. Where the microscopic object is three dimensional, the device may comprise means for determining a height of the microscopic object. Such means may comprise a laser. The height of the microscopic object may comprise at least part of the coded information.

The largest dimension of the microscopic object may be within the range of 30 to 500 micrometers. The microscopic object may be one of a plurality of identical microscopic objects. The microscopic object may be one of a plurality of microscopic objects, and each of the microscopic objects of the plurality of microscopic objects may be unique. The plurality of microscopic objects may be arranged in an array and/or may comprise a repeating pattern of a group of microscopic objects. The plurality of microscopic objects may be arranged randomly.

The plurality of microscopic objects may occupy an entire surface area of a surface located at the predetermined location. The plurality of microscopic objects may occupy one or more portions of a surface area of a surface located at the predetermined location. One or more of the portions may be greater than 10%, 20%, 30%, 40% or 50% of the total surface area of the surface located at the predetermined location.

The distance between adjacent microscopic objects, where a plurality of microscopic objects is provided, may be at least 5 times the largest dimension of the microscopic objects. In some examples the distance between adjacent microscopic objects is at least 10 times, 50 times or 100 times the largest dimension of the microscopic objects.

The camera may comprise an adjustable focal length. The apparatus may further comprise an auto-focusing system configured to automatically adjust the focal length of the camera.

The camera may be configured with a focal length that provides a field of view of less than 5 cm. In some examples, the field of view may be less than 2 cm, or less than 1 cm, or less than 0.5 cm.

The camera may be configured with a scene resolution, i.e. the smallest object that can be distinguished in the field of view, of 50 micrometers or less. In some examples, the scene resolution may be less than 25 micrometers, 20 micrometers, 15 micrometers, 10 micrometers, 5 micrometers, or 2 micrometers.

The device may comprise a plurality of cameras and/or one or more cameras each comprising a plurality of image sensors.

The device may further comprise an inertial system configured to obtain information indicative of: a distance travelled by the device from a last known position, and a direction of travel of the device. The apparatus may comprise a memory device configured to store a location of the microscopic object relative to the last known position. The processor may be configured to determine when the microscopic object appears within a field of view of the camera based on the information obtained by the inertial system and the location of the microscopic object relative to the last known position

The microscopic object may comprise a QR code or other binary code. In other embodiments, the microscopic object may comprise a grey scale code. The processor may be configured to decode a grey scale code by distinguishing between different shades of grey of the grey scale code.

The apparatus may further comprise a memory device. The memory device may be configured to store a plurality of library images each having an associated location. The processor may be configured to decode the coded information by comparing the image captured by the camera to the plurality of library images.

The coded information may comprise location information. The processor may be configured to decode the coded information by processing the image to obtain the location information. The coded information may comprise error detection information. The error detection information may comprise checksum information. The location information may be encrypted. The apparatus may be configured to decrypt the location information. The processor may be configured to decrypt the location information.

The coded information may comprise additional information in addition to the location information. The additional information may comprise: a time and/or date at which the microscopic object and/or the coded information was created; specifications of the processor required to decode the coded information; and/or information relating to an object on which the microscopic object is formed.

The microscopic object may be arranged on a floor of the predetermined location. In other embodiments, the microscopic object may be arranged on a vertical wall or ceiling of the predetermined location, or on an object located within the predetermined location.

The apparatus may further comprise a self-powered or manually operated inventory carrier. The device may be fixed to the inventory carrier

According to another aspect of the invention, there is provided a method of determining a location of a device. The method comprises: capturing an image of a microscopic object located at a predetermined location, the microscopic object comprising coded information; decoding the coded information; and determining the location of the device as being the predetermined location based on the decoded information.

### BRIEF DESCRIPTION OF THE DRAWINGS

Embodiments of the invention will now be described, by way of example only, with reference to the accompanying drawings:

FIG. 1 shows a schematic representation of an apparatus;

FIG. 2a shows a side view schematic representation of a shopping trolley as an example implementation of the apparatus of FIG. 1;

FIG. 2b shows a plan view schematic representation of the shopping trolley of FIG. 2a;

FIG. 3a shows a plan view schematic representation of a supermarket as an example of a predetermined environment in which the implementation of the apparatus of FIGS. 2a and 2b may be used;

FIG. 3b shows a close-up schematic view of the supermarket of FIG. 3a;

FIG. 4 shows a close-up schematic view of a portion of a location of the supermarket of FIGS. 3a and 3b;

FIG. 5 shows a flow-chart illustrating a method of determining a location of a device according to an example embodiment;

FIG. 6 shows a flow-chart illustrating a method according to another example embodiment; and

FIG. 7 shows a close-up schematic view of a portion of a location.

### DETAILED DESCRIPTION

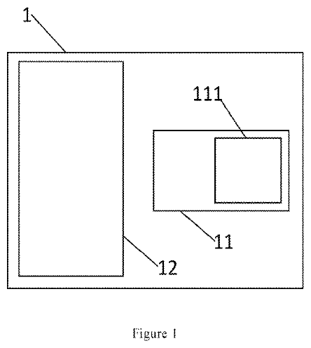

FIG. 1 shows a schematic representation of an apparatus 1 for determining location according to an example embodiment. The apparatus 1 comprises a device 11 and a processor 12. The device 11 comprises a camera 111 configured to capture an image of a microscopic object located at a predetermined location, the microscopic object comprising coded information. The processor 12 is configured to decode the coded information and determine a location of the apparatus 1 as being the predetermined location based on the decoded information.

The camera 111 and processor 12 are in communication with one another such that the image captured by the camera 111 can be received by the processor 12. This communication may be provided by wired or wireless means. In the embodiment of FIG. 1, the processor 12 is implemented in the same packaging as the device 11, and the processor 12 may comprise a micro-controller or a micro-processor. In other embodiments, the processor 12 may be arranged remotely from the device 1, for example as part of a cloud-hosted virtual machine.

In certain embodiments, the apparatus 1 may further comprise a memory device which may be configured to store a plurality of library images each having an associated location. The memory device may comprise non-transitory machine readable media on which are stored the plurality of images and the associated locations. The processor 12 may be configured to decode coded information of a microscopic object by comparing an image of the microscopic object captured by the camera 111 to the plurality of library images. The processor 12 may be configured to determine a location of the device 11 as the location associated with the library image that is determined by the processor 12 to be a positive match (e.g. the most likely match) with the image captured by the camera 111. The coded information of the microscopic object may take the form of any predetermined pattern or arrangement of lines that is distinguishable from the coded information of another microscopic object and any non-predetermined, e.g. pre-existing, microscopic object.

In certain embodiments, coded information of a microscopic object may comprise location information (e.g. encoded plain text co-ordinates or similar). The processor 12 may be configured to decode the coded information by processing an image of the microscopic object captured by the camera 111 to obtain the location information. The coded information may comprise error detection information, such as checksum information. The location information may be encrypted, for example by means of a private key. The processor 12 may be configured to decrypt the location information, for example by means of a public key corresponding to the private key.

The microscopic object may comprise a binary code, such as a QR code, and the processor 12 may process an image of the binary code captured by the camera 111 using known techniques. The processor 12 may be configured to determine a location of the device 11 based on the location information obtained from processing an image of the microscopic object.

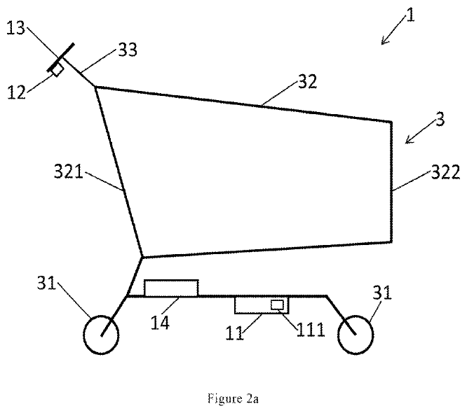

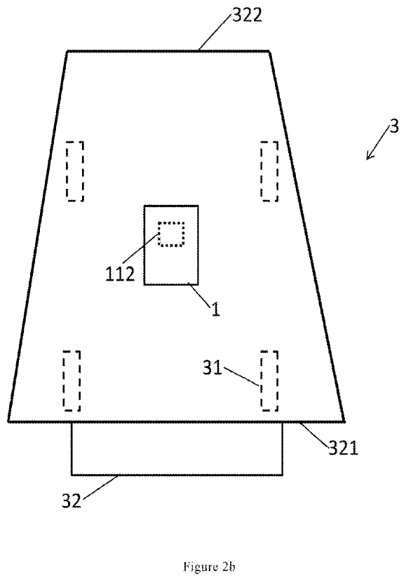

In certain embodiments, the apparatus 1 may be used to locate an inventory carrier within a predetermined environment, such as a shopping cart in a supermarket or a mobile drive unit in a warehouse (or fulfillment center). The mobile drive unit may be robotic and/or autonomous, and the warehouse may be at least partially automated. Alternatively, the mobile drive unit may be remotely controllable by an operator. FIGS. 2a and 2b show an example implementation of the apparatus 1 in the context of a shopping trolley or cart 3. A similar arrangement may be used for a mobile drive unit.

FIGS. 2a and 2b show one example implementation of the apparatus 1. FIG. 2a shows a side view schematic representation of the apparatus 1 comprising a shopping cart 3. FIG. 2b shows a plan view schematic representation of the apparatus 1. The device 11 is attached to the underside of the shopping cart 3 such that the camera 111 is directed towards the ground in use.

In the embodiment of FIGS. 2a and 2b, the apparatus 1 further comprises a screen 13, which is mounted on a handle 33 of the shopping cart 3. The screen 13 may be provided with wired or wireless communication with the processor 12. The screen 13 may be configured to display information received from the processor 12. The screen 13 may also provide an input to the processor 12, for example by means of a capacitive touch screen. In this embodiment, the processor 12 is implemented with the screen 13. In other embodiments, the processor 12 and the screen 13 may be implemented separately. In certain embodiments, the screen 13 may be part of a mobile device such as a mobile phone or a tablet. For example, a user of the shopping cart 3 may use their own mobile device with the apparatus 1. In such examples, the user may establish a wireless communication link, for example via Bluetooth®, between their mobile device and the processor 12 prior to use of the apparatus 1. In embodiments for robot and/or autonomous mobile drive units, there may be no screen, and the information may be directly used, for example by a routing subsystem.

In the example of FIGS. 2a and 2b, the apparatus 1 further comprises a battery 14. The battery 14 is configured to provide electrical power to the camera 111, the processor 12 and the screen 13. The battery 14 may be rechargeable or replaceable. In other examples, electrical power may be provided to the camera 111, the processor 12 and the screen 13 by means other than the battery 14. For example, the apparatus 1 may be configured to receive electrical power inductively through an inductive element arranged with floor of an environment within which the apparatus 1 is used.

In the example of FIGS. 2a and 2b, the shopping cart 3 comprises four wheels 31, one of the wheels 31 being located in each of the four corners of the shopping cart 3. The shopping cart 3 comprises a carrier portion 32 comprising a rear edge 321 and a front edge 322. The handle 33 extends from the rear edge 321 of the carrier portion 32. The dotted square 112 shown in FIG. 2b represents the field of view of the camera 111. As shown, the field of view 112 extends in parallel to and perpendicularly to the rear edge 321 and front edge 322 of the carrier portion 32.

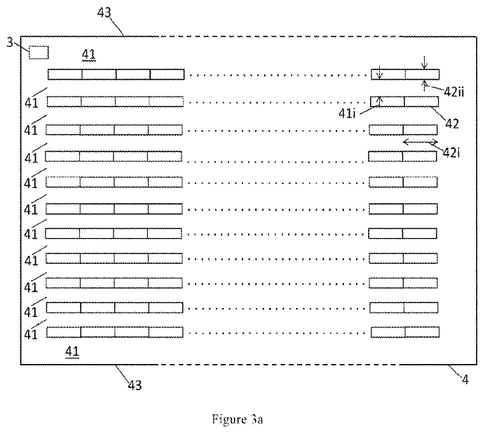

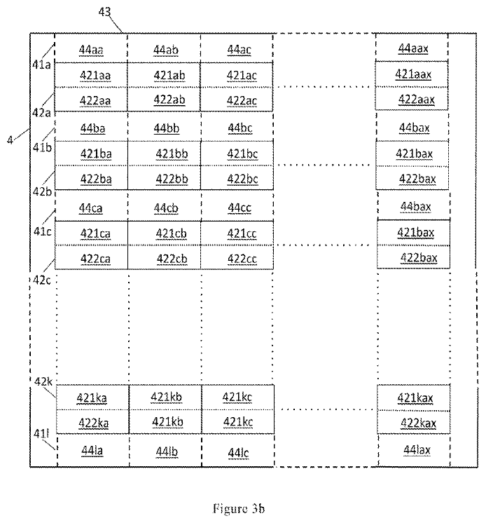

FIGS. 3a and 3b show one example of a predetermined environment in which the implementation of the apparatus 1 described with reference to FIGS. 2a and 2b may be used. In the example of FIGS. 3a and 3b, the predetermined environment is a supermarket 4. FIG. 3a shows a plan view schematic representation of the supermarket 4. In this example, the supermarket 4 comprises twelve aisles 41 defined by eleven rows of shelf units 42 and the side walls 43 of the supermarket 4. Each of the shelf units 42 is one meter long (dimension 42i) and half a meter wide (dimension 42ii). Each row of shelf units 42 comprises fifty shelf units 42. The distance between opposite shelf units 42 of adjacent rows is five meters (dimension 41i). This configuration is merely illustrative; in other embodiments the number of aisles, the configuration and number of shelf units, and the dimensions of the shelf units and distance between opposite shelf units may be different.

FIG. 3b shows a close-up schematic plan view of the supermarket 4. Each shelf unit 42a-1 comprises a pair of back-to-back shelves 421, 422. A different item is located on each shelf 421, 422. The supermarket 4 is divided in to a plurality of locations 44aa-441ax. Each location 44 corresponds to a given shelf 421, 422 of a given shelf unit 42 of a given aisle 41. There are a total of 1100 different locations 44 within the supermarket 4. As mentioned above, this configuration is merely illustrative and the number of locations may differ in other embodiments.

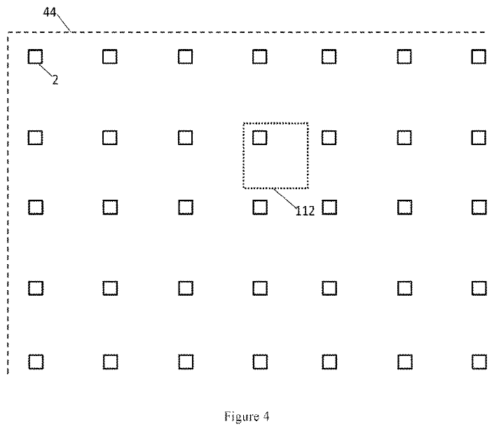

FIG. 4 shows a close-up schematic view of a portion of one of the locations 44. Arranged on the floor of each of the locations 44 is an array of microscopic objects 2. Each microscopic object 2 comprises coded information. In certain embodiments, each microscopic object 2 may comprise a QR (Quick Response) code 2. Each microscopic object 2 may comprise an edge length in the range of 50 to 500 microns. Any shape may be used in principle. An example embodiment will be described in which a square QR code 2 is used with a 500 micrometer edge length (i.e. 0.5 mm×0.5 mm). In alternative examples, each QR code 2 may be smaller.

In the example of FIG. 4, each QR code 2 within each location 44 is identical and comprises coded information that is unique to a given location 44. In some embodiments, every QR code 2 arranged on the floor of the supermarket 4 is unique, and a unique subset of the QR codes 2 is arranged on the floor of each location 44. In the event that one or some of the QR codes 2 at a given location are obscured, or for any other reason the camera 111 is unable to capture an image of one or some of the QR codes 2 at a given location, the location of the device 11 can still be determined using another of the QR codes 2 at the given location. Because each of the plurality of QR codes 2 at a given location 44 is unique to that location 44, any one of the QR codes 2 at a given location 44 can be used to determine the location of the device 11.

Where each QR code 2 within each location 44 is identical, there are 1100 different QR codes 2 arranged on the floor of the supermarket 4. In certain embodiments, each QR code 2, when decoded, may comprise a different four digit number between 0001 and 1100 which is associated with a given location 44. In other embodiments, each QR code 2 represents a unique combination of letters and numbers or a universally unique identifier (also known as a globally unique identifier) associated with a given location 44. In other embodiments, each QR code 2 comprises location information associated with a given location. For example, referring to FIG. 3b, each QR code 2 within location 44aa may represent the information ‘44aa’. In this example, each QR code 2 is a Version 1 QR code which comprises a 21×21 array of elements. Version 1 QR codes provide a high enough number of unique QR codes in order to represent each of the 1100 individual locations of this example. In other examples, for example with a higher number of locations, higher order version QR codes may be used instead.

In some embodiments the microscopic object may printed on the floor surface (e.g. with an inkjet or electrostatic printer) machined, etched or otherwise formed in the floor surface (e.g. as a relief pattern). In other embodiments the microscopic object may be fabricated (e.g. printed), and subsequently adhered to the floor surface. The microscopic object may comprise a sticker that is transparent except in the location of the microscopic object. In principle, any method may be used to produce the microscopic object on the floor surface. In some embodiments, the same system used to produce the microscopic object on the floor surface may also be used to generate the coded information of the microscopic object. For example, such a system may comprise one or more processors configured to generate coded information, and a forming means configured to produce a microscopic object comprising the coded information.

A process of producing the microscopic objects on the floor of the supermarket 4 may comprise repeating the steps of forming a microscopic object on the floor and recording the location of the microscopic object. The process may alternatively or additionally comprise forming a plurality of the microscopic objects on the floor, followed by a calibration step in which the location of each of the plurality of the microscopic objects is recorded.

A high degree of contrast between the color of the elements of the QR codes 2 and the color of the floor may be provided to ensure that the processor 12 is able to decode the information represented by the QR codes 2 even when the camera 111 captures images of the QR codes 2 in low levels of light. In this example, the floor is white and the elements of the QR codes 2 are black, but the microscopic object may comprise any color, including those that are not within the visible spectrum (e.g. UV and/or IR pigments).

In some examples, the apparatus 1 may further comprise one or more light sources configured to provide additional lighting when ambient lighting is not sufficient to capture images of the QR codes 2 that can be decoded by the processor 12.

The camera 111 comprises a rectilinear lens and an image sensor which are used to capture an image of one of the QR codes 2. Given that each QR code 2 in the example embodiment comprises 21 elements in both the horizontal and vertical directions, and that each QR code 2 measures 0.5 mm×0.5 mm, the image sensor is required to have a magnified pixel size of at least 24 micrometers (0.024 mm) so as to distinguish each of the individual elements of the QR codes 2. In other embodiments, the resolution requirements may differ, depending on the nature of the coded information.

Example specifications of the camera 111 will now be described based on the use of an example image sensor configured within the camera 111 to provide the magnified pixel size. The image sensor used in this example comprises a horizontal dimension of 1.84 mm, a vertical dimension of 1.04 mm and a non-magnified pixel size of 1.4 micrometers (0.0014 mm). An example of a commercially available sensor comprising similar specifications is the OmniVision® OV9724, and is of the type found within portable devices such as mobile phones and tablets. The following example is merely illustrative and different image sensors with different camera specifications may be used to achieve the same objective.

The shopping cart 3 may be configured to move in all directions within a particular location 44; for example the shopping cart 3 may be configured to move forward, backward, left, right and diagonally. In the example of FIG. 4, the camera 111 is configured with a field of view 112 which always encompasses at least one of the QR codes 2 independently of the orientation of the shopping cart 3. In the embodiment of FIG. 4, each of the QR codes 2 may be spaced from the nearest other QR code 2 by 20-40 mm in the horizontal direction and a similar amount in the vertical direction. The field of view 112 may be configured to ensure that a QR code 2 always remains within the field of view 112.

In certain embodiments, the spacing between QR codes 2 may be greater. The dimensions and spacing of the QR codes 2 ensures that the codes are not visible to the naked human eye. As such, the QR codes 2 cannot be easily located, which mitigates tampering of the QR codes 2. In some examples, the QR codes 2 are applied to the floor using a luminous/fluorescent paint which is not visible under normal ambient lighting. This further decreases the detectability of the QR codes 2 and further mitigates tampering. In such examples, the apparatus 1 may comprise a UV light source to enable images of the QR codes 2 to be captured by the camera 11.

A suitable clearance between the lens of the camera 111 and the floor of the supermarket 4 is provided to ensure that the lens remains clear of any typical debris that may be located on the floor of the supermarket 4. The clearance may be less than 50 mm, or less than 100 mm, 200 mm, 400 mm, or 600 mm. In other examples, the clearance may be greater.

Given the parameters of an image sensor, the required field of view of the camera, and the clearance between the lens of the camera 111 and the floor of the supermarket 4, the focal length of the camera may be calculated. A similar approach may be used to determine sensor requirements from an optical design.

The angle of view in a given horizontal, vertical or diagonal direction provided by a rectilinear lens separated by a given focal distance from a sensor of a given size can be approximated using the following well-known equation:

$$∝ = 2 {tan}^{- 1} \frac{x}{2 f} \qquad [ Equation 1 ]$$

In equation 1, α is the angle of view in a given horizontal, vertical or diagonal direction, x is the dimension of the sensor in the same horizontal, vertical or diagonal direction as the angle of view, and f is the focal distance. Equation 1 can be rearranged to solve for f:

$$f = \frac{x}{2 tan ( \frac{∝}{2} )} \qquad [ Equation 2 ]$$

The angle of view in a given horizontal, vertical or diagonal direction can be calculated using the following equation, where d is the clearance between the lens of the camera 111 and the floor, F is the field of view in the given direction and a is the angle of view in the given direction:

$$∝ = 2 tan ( \frac{F}{2 d} ) \qquad [ Equation 3 ]$$

A suitable resolution in the field of view for the camera will be sufficient for reading the coded information from the microscopic object. Where the coded information comprises minimum features that are 25 microns in dimension, the resolution in the field of view may be better than 12.25 microns (for example). In certain embodiment the resolution in the field of view may be at least twice the minimum feature size of the coded information in the microscopic object.

As mentioned above, this example is merely an illustrative example demonstrating the type of image sensors and camera focal lengths that can be used to achieve the object of the invention.

In certain embodiments, the camera 111 comprises an adjustable focal length to account for any variations in the clearance between the lens of the camera 111 and the floor, or any other manufacturing variations of the apparatus 1. This may be used in conjunction with an auto-focusing system to adjust the focal length to ensure that the camera 111 is sufficiently focused to capture images of the QR codes 2 that can be decoded by the processer 12.

In some embodiments, the device 11 may comprise a plurality of cameras and/or one or more cameras each comprising a plurality of image sensors. Any suitable arrangement of cameras and/or image sensors may be used to provide a resolution required to achieve the object of the invention.

The microscopic objects 2 arranged on the floor at a given one of the locations 44 may occupy the entire surface area of the floor at the given location 44. As such, if a portion of the floor at the given location 44 is obscured, or if for any other reason the camera 111 is unable to capture an image of one or more of the QR codes 2 on a portion of the floor at the given location 44, there will still be a portion of the floor at the given location 44 comprising microscopic objects 2 which can be used to determine the location of the apparatus 1. In some embodiments, the microscopic objects 2 arranged on the floor at a given one of the locations 44 may occupy a portion of a surface area of the floor at the given the location 44.

In some embodiments, the camera 111 may be configured with a field of view 112 which always encompasses at least two of the QR codes 2. The camera 111 may comprise a rectilinear lens and an image sensor configured to provide a magnified pixel size so as to distinguish each of the individual elements of each of the at least two QR codes 2. In such embodiments, if one or some of the at least two QR codes 2 is obscured and is unreadable by the camera 111 for any reason, the location of the apparatus 1 can still be determined by means of the other QR code(s) 2.

In some embodiments, a random arrangement of microscopic objects 2 may be arranged on the floor of one or more of the locations 44. An average spacing between the microscopic objects 2 within the random arrangement may be predetermined. In such embodiments, the camera 111 may be configured such that at least one of the random arrangement of microscopic objects 2 is always in the field of view of the camera 111.

In some embodiments, one or more of the microscopic objects 2 may be three dimensional. In such embodiments, the device 11 may further comprise means for determining a height of the microscopic objects 2, such as a laser transmitter and receiver. The height of the microscopic objects 2 may comprise at least part of the coded information used to determine the location of the device 11.

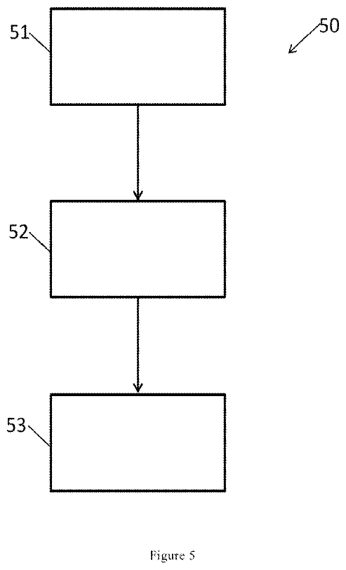

FIG. 5 shows a flow-chart illustrating a method 50 of determining a location of a device, according to an example embodiment. At step 51, an image is captured of a microscopic object located at a predetermined location, the microscopic object comprising coded information. After step 51, the method 50 comprises decoding the coded information at step 52. After step 52, the method 50 comprises determining the location of the device as being the predetermined location based on the decoded information. The device may be the device 11 of any of the above described examples. The microscopic object may be a microscopic object of any of the above described examples, for example of the QR codes 2, 72.

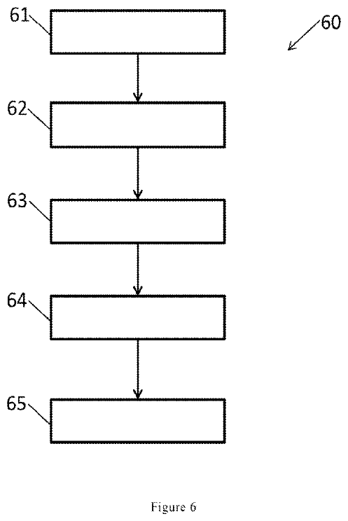

FIG. 6 shows a flow-chart illustrating a method 60 according to another example embodiment. The method 60 may be used to determine the location of the shopping cart 3 of any of the above described examples within the supermarket 4. The method 60 may begin at step 61 with a user of the shopping cart 3 initiating the process of determining the location of the shopping cart 3. This may be achieved by the user selecting an icon on the screen 13 which instructs the processor 12 to begin the process. In alternative examples, the apparatus 1 may comprise physical buttons or switches which provide an input to the processor 12.

After the process has been initiated, a message is displayed on the screen 13, at step 62, which informs the user that the shopping cart 3 must be held stationary during the location determining process. In embodiments in which the camera 111 comprises an adjustable focal length, the auto focusing system adjusts the focal length, at step 63, until one of the QR codes 2, 72 is in suitable focus within the field of view 112. The camera 111 then captures an image of the QR code 2 at step 64. The processor 12 then processes the image at step 65 to decode the coded information of the QR code 2. This may be achieved using a library of images or by decoding location information of the QR code 2, as described above.

In certain embodiments, the apparatus 1 comprises a memory device configured to store information relating to items located on each of the shelves 421 or 422 at each of the locations 44. A map of the supermarket 4 may also be stored within the memory device. Once the location of the shopping cart 3 has been determined, the user can input in to the processor 12, for example by means of the screen 13, a desired item. The processor 12 can then access the look-up table and identify the location 44 of the desired item within the supermarket 4. The processor 12 can then determine, by using the map for example, a route through the supermarket 4 from the current location of the shopping cart 3 to the location 44 of the desired item. The processor may display the route on the screen 13 for the user to follow.

In some embodiments, the apparatus 1 further comprises an inertial system in communication with the processor 12. The inertial system is configured to measure distance travelled by the shopping cart 3 from a fixed known position. The inertial system is also configured to determine the direction of travel of the shopping cart 3. In some examples, the inertial system comprises one or more accelerometers used to measure distance travelled and direction of travel. The fixed known position may be a storage location within the supermarket 4 from which a user collects the shopping cart 3. The apparatus 1 comprises a memory device configured to store the fixed known position and the distance between the individual QR codes 2.

The processor 12 may be configured to determine when a QR code 2 is encompassed entirely within the field of view 112 of the camera 111 using direction and distance information provided by the inertial system, and using the known distance between QR codes 2. Whenever a QR code 2 is encompassed entirely within the field of view 112, the processor 12 can instruct the camera 111 to capture an image of the QR code 2 to be subsequently processed. The skilled person will appreciate that the shutter speed and focal ratio (f-number) of the camera 111 will be suitably selected to ensure an image of the QR code 2 that is capable of being interpreted by the processor 12 is captured. In this way, the apparatus 1 is configured to determine the location of the shopping cart 3 as the shopping cart 3 is moved around the supermarket 4. This enables the apparatus 1 to verify if the user is following the determined route, as described above, and may alert the user if they deviate from the route. Another advantage of this example is that the QR codes 2 can be spaced further apart, making it more difficult for an unauthorized person to locate and tamper with the QR codes 2.

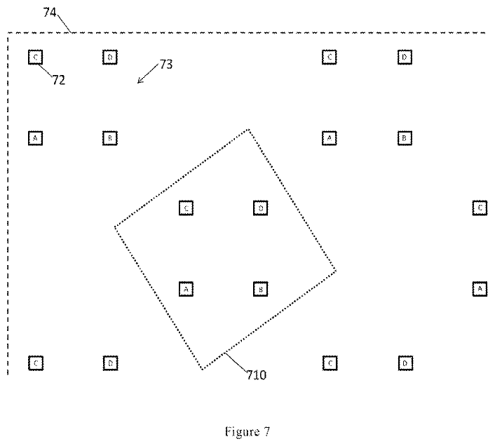

FIG. 7 shows a close-up schematic view of a portion of a location 74 according to an embodiment. Arranged on the floor of the location 74 is a repeating pattern 73 of four unique microscopic QR codes 72 labelled ‘A’, ‘B’, ‘C’ and ‘D’. Each of a plurality of locations 74 comprises a different repeating pattern of the four unique microscopic QR codes 72. For example, the repeating pattern shown in FIG. 7 reads, anti-clockwise from the bottom left of the pattern, ‘A’, ‘B’, ‘C’, ‘D’. A different location 74 of the plurality of locations may have a repeating pattern reading B, A, C, D. In this way, 24 different repeating patterns can be provided to represent 24 different locations 74 using only 4 different unique QR codes 72. This arrangement may be particularly useful when the number of different available QR codes 2 of the appropriate size is less than the total number of locations 44.

In the example of FIG. 7, the focal distance of the camera 111 is configured such that the field of view 710 can encompass all four QR codes 72 of a repeating pattern 73 independently of the orientation of the shopping cart 3. Each repeating pattern 73 within a location 74 is spaced from adjacent repeating patterns 73 such that whenever four QR codes 72 are encompassed within the maximum field of view 710, the four QR codes 72 can only be from the same repeating pattern 73.

The processor 12 is configured to instruct the camera 111 to capture an image whenever four QR codes 72 are detected within the field of view 710. In some examples, the inertia system is used as described above to determine when the field of view 710 encompasses four QR codes 72. In other examples, the user can be instructed using the display 13 to maneuver the shopping cart 3 until four QR codes 72 are encompassed within the field of view 710.

Due to the unique sequence of QR codes 72 in each repeating pattern 73, the processor 12 is able to identify a particular repeating pattern 73 even if one of the QR codes 72 within the repeating pattern 73 is obscured or otherwise unreadable. Taking the ‘A’, ‘B’, ‘C’, ‘D’ repeating pattern 73 as an example, if the ‘B’ QR code 72 is unreadable, the apparatus 1 is still able to determine from the partial sequence ‘A’, ‘C’, ‘D’ that the repeating pattern 73 is the ‘A’, ‘B’, ‘C’, ‘D’ repeating pattern 73, because no other repeating pattern 73 comprises ‘A’, ‘C’ and ‘D’ as the first, third and fourth QR codes 2 respectively.

The above described examples enable the location of the shopping cart 3 within the supermarket 4 to be determined without requiring the use of a signal received by the apparatus 1 from a source external to the apparatus 1.

As an alternative to the shopping cart 3 and supermarket 4 described above, the apparatus 1 may be implemented as comprising a robotic inventory carrier operable within an inventory facility, with the array of microscopic objects 2, 72 arranged on the floor of the inventory facility. The robotic inventory carrier may comprise an inventory holder for containing inventory, a chassis supporting the inventory holder, three or more wheels rotatably connected to the chassis to enable the robotic inventory carrier to be moved over the floor of the inventory facility, and an electric motor configured to drive one or more of the wheels. One or more of the wheels are steerable to enable the direction of travel of the robotic inventory carrier to be altered. The robotic inventory carrier may also comprise the inertial system described above. The processor 12 may be configured to control the electric motor and the one or more steerable wheels. The inventory facility may comprise aisles and shelf units defining locations as described above with reference to the supermarket 4, with a different item of inventory located at each of the locations.

In the robotic inventory carrier example, the robotic inventory carrier may be operated using a similar method as described above with reference to FIG. 5 or 6. Instructions may be provided to the processor 12 by means of wireless communication from a remote control unit. In use, an operator can initiate the location determining process and input a desired location for the robotic inventory carrier to move to using the remote control unit. In some examples, the robotic inventory carrier may be autonomous and configured to operate according to a predetermined set of rules. In some examples, the apparatus 1 may comprise a memory device and the processor 12 may be configured to update and store a location of the robotic inventory carrier within the memory device. The location may be updated and stored continuously and/or at predetermined intervals.

Once the apparatus 1 has determined the initial location of the robotic inventory carrier, for example as described above with reference to the shopping cart 3, the processor 12 will then determine a route through the inventory facility from the initial location to the desired location. The processor 121 will then instruct the electric motor and one or more steerable wheels to maneuver the robotic inventory carrier to the desired location. As the robotic inventory carrier moves through the inventory facility, the processor 12 may receive information from the inertial system to determine the distance travelled and in which direction from the initial location. The processor 12 can then determine, for example with reference to a map of the inventory facility stored within a memory apparatus, when the robotic inventory carrier has reached the desired location. When the desired location has been reached, the processor 12 can instruct the electric motor to bring the robotic inventory carrier to a halt. At this stage, a second operator can place the inventory located at the desired location in to the inventory holder, following which the robotic inventory carrier can be controlled as described above to transport the inventory to a second desired location.

The above described example enables the location of the robotic inventory carrier within the inventory facility to be determined without requiring the use of a signal received by the apparatus 1 from a source external to the apparatus 1.

Another example application of the apparatus 1 comprises a robotic or manually operated floor cleaning apparatus. As the floor cleaning apparatus is used to clean a floor on which an array of QR codes 2, 72 are arranged, the apparatus 1 is able to monitor which areas of the floor the floor cleaning apparatus has passed over and which areas of the floor are still to be cleaned. Another example includes the apparatus 1 being implemented with a vehicle for navigation around a predetermined indoor or outdoor area comprising the array of QR codes 2, 72. A further example includes the apparatus 1 being implemented with footwear to enable determination of a location of a wearer of the footwear. When implemented with footwear, the apparatus 1 may be configured to enable wireless communication between the apparatus 1 and a portable communications device, such as a mobile phone, of the wearer, with the apparatus 1 being configured to communicate the location to the portable communications device.

Although the use of QR codes has been described in the above examples, this is just one example of a unique computer-readable image that can be used. In other examples, an alternative barcode or a microdot is used instead of a unique QR code 2, 72.

The above description is merely exemplary, and the scope of the invention should be determined with reference to the accompanying claims.

1. An apparatus for determining location, comprising:
a device comprising a camera configured to capture an image of a microscopic object located at a predetermined location, the microscopic object comprising coded information; and
a processor configured to decode the coded information and determine a location of the device as being the predetermined location based on the decoded information.

2. The apparatus of claim 1, wherein the largest dimension of the microscopic object is within the range of 30 to 500 micrometers.

3. The apparatus of claim 1, wherein the microscopic object is one of a plurality of identical microscopic objects arranged in an array.

4. The apparatus of claim 1, wherein the microscopic object is one of a plurality of microscopic objects, and the plurality of microscopic objects comprises a repeating pattern of a group of microscopic objects.

5. The apparatus of claim 3, wherein the distance between adjacent microscopic objects is at least 5 times the largest dimension of the microscopic objects.

6. The apparatus of claim 1, wherein the camera comprises an adjustable focal length.

7. The apparatus of claim 1, wherein the camera is configured with a focal length that provides a field of view of less than 5 cm.

8. The apparatus of claim 7, wherein the camera is configured with a scene resolution of 25 micrometers or less.

9. The apparatus of claim 1, wherein:
the device comprises an inertial system configured to obtain information indicative of: a distance travelled by the device from a last known position, and a direction of travel of the device;
the apparatus comprises a memory device configured to store a location of the microscopic object relative to the last known position; and
the processor is configured to determine when the microscopic object appears within a field of view of the camera based on the information obtained by the inertial system and the location of the microscopic object relative to the last known position.

10. The apparatus of claim 1, wherein the microscopic object comprises a QR code or other binary code.

11. The apparatus of claims 1 or 10, comprising a memory device, wherein the memory device is configured to store a plurality of library images each having an associated location, and the processor is configured to decode the coded information by comparing the image to the plurality of library images.

12. The apparatus claim 11, wherein the coded information comprises location information, and the processor is configured to decode the coded information by processing the image to obtain the location information.

13. The apparatus of claim 10, wherein the microscopic object is arranged on a floor of the predetermined location.

14. The apparatus of claim 10, comprising a self-powered or manually operated inventory carrier, wherein the device is fixed to the inventory carrier.

15. A method of determining a location of a device, the method comprising:
capturing an image of a microscopic object located at a predetermined location, the microscopic object comprising coded information;
decoding the coded information; and
determining the location of the device as being the predetermined location based on the decoded information.

16. The method according to claim 15, wherein the method comprises:
providing a microscopic object wherein the largest dimension of the microscopic object is within the range of 30 to 500 micrometers;
providing a microscopic object that is one of a plurality of identical microscopic objects arranged in an array; and
arranging the microscopic objects such that the distance between adjacent microscopic objects is at least 5 times the largest dimension of the microscopic objects.

17. The method according to claim 15 or 16, wherein the method comprises:
obtaining information using an inertial system, the information being indicative of: a distance travelled by the device from a last known position, and a direction of travel of the device;
configuring a memory device to store a location of the microscopic object relative to the last known position; and
determining via a processor when the microscopic object appears within a field of view of the camera based on the information obtained by the inertial system and the location of the microscopic object relative to the last known position.

18. The method according to claim 16, wherein the microscopic object comprises a QR code or other binary code.
